(19) United States
(12) Patent Application Publication
(10) Pub. No.: US 2011/0205316 A1
(43) Pub. Date: Aug. 25, 2011

(54) FLUID EJECTING APPARATUS

(75) Inventors: Akihiko IKEGAMI, Okaya-shi (JP); Osamu SHINKAWA, Chino-shi (JP); Keiji HARA, Minowa-machi (JP)

(73) Assignee: SEIKO EPSON CORPORATION, Tokyo (JP)

(21) Appl. No.: 13/032,450

(22) Filed: Feb. 22, 2011

(30) Foreign Application Priority Data
Feb. 22, 2010 (JP) 2010-035774

(51) Int. Cl. B41J 2/175

(52) U.S. Cl. 347/85

(57) ABSTRACT

At a transport pathway which transports recording paper, a passage flow path which can pass the recording paper and gas from the upstream side toward the downstream side in a transport direction is provided and also a reversing flow path portion which reverses the recording paper by passing the recording paper while twisting and rotating the recording paper with an axis line extending in the transport direction as a rotation center is provided at the passage flow path.

The entire disclosure of Japanese Patent Application No. 2010-035774, filed Feb. 22, 2010, is expressly incorporated herein by reference.

### BACKGROUND

1. Technical Field

The present invention relates to a fluid ejecting apparatus such as an ink jet printer.

2. Related Art

In general, as one type of fluid ejecting apparatus, an ink jet printer which prints an image composed of characters, graphics, or the like on a target by ejecting ink (fluid) onto the target is widely known (refer to JP-A-2008-74532, for example). On the printer described in JP-A-2008-74532, a printing section which carries out a printing process with respect to paper (target) and a reversing transport pathway for reversing the paper, in which the printing process has been carried out in the printing section, are provided.

The reversing transport pathway is constituted by combining three reversing mechanisms. Each reversing mechanism is made so as to reverse the paper while sliding the transported paper to follow a reversing transport surface made of a curved inner circumferential surface. Then, in this printer, a configuration is made such that by reversing the paper, in which printing has been carried out on a printing surface in the printing section, by the reversing transport pathway and then transporting the paper again to a position which is further on the upstream side in a transport direction of the paper than the printing section, a printing process is also carried out with respect to a back surface on the opposite side to the printing surface of the paper in the printing section.

Incidentally, in recent printers, it is required to further speed up printing speed with respect to paper. However, in the printer described in JP-A-2008-74532, the paper is reversed while pressing the paper against the reversing transport surface of the above-described reversing transport pathway. For this reason, in the printer described in JP-A-2008-74532, if the printing speed with respect to the paper is increased, the paper, which has ink therein, thereby being in the state of low stiffness, is pressed against the reversing transport surface of the reversing transport pathway. As a result, there is a risk that the paper is greatly bent and deformed in the reversing transport pathway, thereby inducing a transport jam.

### SUMMARY

An advantage of some aspects of the invention is that it provides a fluid ejecting apparatus which allows a target to be reversed while avoiding occurrence of transport jams of the target in a transport pathway.

According to a first aspect of the invention, there is provided a fluid ejecting apparatus that ejects liquid from a fluid ejecting head which ejects fluid, onto a target which is transported in a transport pathway, the apparatus including: a passage flow path which passes the target with the liquid ejected thereto and gas on the downstream side of the fluid ejecting head in the transport pathway; a reversing flow path portion which is connected to the passage flow path and reverses the front side and the back side of the target by rotating the target with an axis line extending in a transport direction as a rotation center; and a carrying-out port which carries out the target passed through the reversing flow path portion, to a position which is further on the upstream side than the ejecting head.

According to the above configuration, the target is reversed without coming into contact with the inner surfaces of the passage flow path, by gas flowing in the passage flow path. For this reason, even in the case of reversing the target at a position on the way of the passage flow path, it is possible to avoid occurrence of a transport jam of the target in the passage flow path.

Also, in the fluid ejecting apparatus according to the above aspect of the invention, the reversing flow path portion may have a flow path cross-sectional shape that is a point-symmetric shape with an axis line as the center.

According to the above configuration, both sides in the width direction of the target are reversed in the same direction with the axis line extending in the transport direction of the target as a rotation center in a process in which the target passes through the reversing flow path portion. For this reason, since a biasing force from gas acts on the target in a balanced manner, it is possible to smoothly reverse the target.

Also, in the fluid ejecting apparatus according to the above aspect of the invention, the reversing flow path portion may be configured such that a flow path cross-section area gradually becomes small as it goes from the upstream side to the downstream side in the transport direction.

According to the above configuration, the flow velocity of gas flowing in the reversing flow path portion gradually increases as the flow path cross-section area of the reversing flow path portion gradually becomes small. For this reason, the target is reversed while always receiving a force pulling it toward the downstream side in the transport direction, so that it is possible to avoid occurrence of a transport jam of the target in the reversing flow path portion.

### BRIEF DESCRIPTION OF THE DRAWINGS

The invention will be described with reference to the accompanying drawings, wherein like numbers reference like elements.

FIG. 1 is a partially fractured cross-sectional view schematically showing the schematic configuration of a printer of an embodiment.

FIG. 2A is an arrow cross-sectional view taken along the line IIA-IIA of FIG. 1, FIG. 2B is an arrow cross-sectional view taken along the line IIB-IIB of FIG. 1, FIG. 2C is an arrow cross-sectional view taken along the line IIC-IIC of FIG. 1, FIG. 2D is an arrow cross-sectional view taken along the line IID-IID of FIG. 1, and FIG. 2E is an arrow cross-sectional view taken along the line IIE-IIE of FIG. 1.

FIG. 3 is a partially fractured cross-sectional view showing a state just after recording paper is distributed to a second flow path section.

FIG. 4A is a cross-sectional view showing a state where the recording paper is transported in an upstream-side portion of a reversing flow path portion, FIG. 4B is a cross-sectional view showing a state where the recording paper is transported in an intermediate portion of the reversing flow path portion, FIG. 4C is a cross-sectional view showing a state just after the recording paper passes through the intermediate portion of the reversing flow path portion, FIG. 4D is a cross-sectional view showing a state where the recording paper is transported in a downstream-side portion of the reversing flow path portion, and FIG. 4E is a cross-sectional view showing a state where the recording paper is transported in a downstream-side end portion of the reversing flow path portion.

FIG. 5 is a partially fractured cross-sectional view showing a state where a printing process is carried out with respect to the back surface of the recording paper.

FIG. 6 is a partially fractured cross-sectional view showing a state just after the recording paper is distributed to a first flow path section.

FIG. 7 is a partially fractured cross-sectional view schematically showing the schematic configuration of a printer of another embodiment.

### DESCRIPTION OF EXEMPLARY EMBODIMENTS

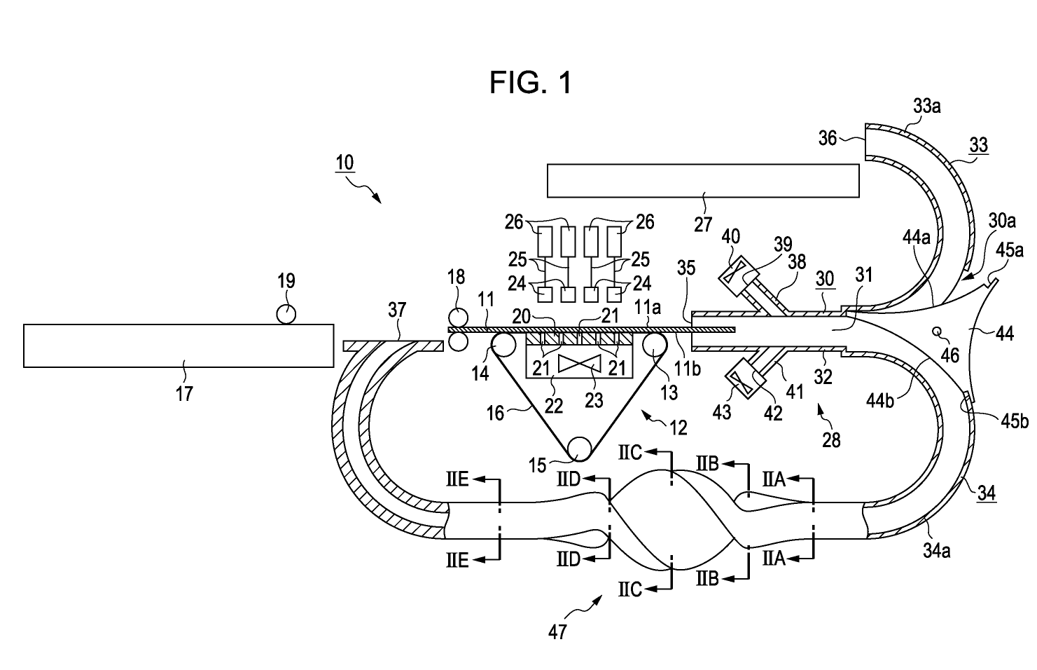

Hereinafter, an embodiment that embodies a fluid ejecting apparatus according to the invention in an ink jet printer will be described on the basis of FIGS. 1 to 6.

As shown in FIG. 1, an ink jet printer 10 as a fluid ejecting apparatus is provided with a belt transport device 12 for transporting recording paper 11 as a target. The belt transport device 12 includes a driving roller 13 provided at a position which is on the downstream side (in FIG. 1, the right side) in a transport direction of the recording paper 11, a driven roller 14 provided at a position which is on the upstream side (in FIG. 1, the left side) in the transport direction of the recording paper 11, and a tension roller 15 disposed slightly below an approximately middle position between the driving roller 13 and the driven roller 14. An endless transport belt 16 is wound around the respective rollers 13 to 15 so as to surround the respective rollers 13 to 15.

A paper feeding tray 17 is provided at the upstream side of the belt transport device 12. Also, gate rollers 18 are provided between the paper feeding tray 17 and the belt transport device 12. Then, the recording papers 11 stacked in the paper feeding tray 17 are fed one by one to the belt transport device 12 through the gate rollers 18 by a paper feeding roller 19.

A rectangular plate-shaped platen 20 is provided at a position inside the transport belt 16 and between the driving roller 13 and the driven roller 14 in such a manner that the upper surface thereof is brought into contact with the transport belt 16. Then, the transport belt 16 is made so as to slide on the upper surface of the platen 20 when transporting the recording paper 11 placed on the upper surface thereof from the upstream side toward the downstream side. Also, in the transport belt 16, a number of venting holes (not shown) are formed so as to pass through between the surface thereof and the back surface which comes into sliding contact with the upper surface of the platen 20. On the other hand, in the platen 20, a number of suction holes 21 which penetrate the platen 20 in the up-and-down direction (the thickness direction of the platen 20) are formed. These suction holes 21 are formed at positions respectively corresponding to the respective venting holes of the transport belt 16.

An approximately box-shaped inducement blower 22 for providing suction to the respective suction holes 21 is provided below the platen 20 so as to cover openings of the respective suction holes 21 at the bottom side of the platen 20. Also, a suction fan 23 is provided at the inside of the inducement blower 22. Then, if negative pressure is generated at the inside of each suction hole 21 by suction according to the driving of the suction fan 23, suction power is applied to the recording paper 11 placed on the transport belt 16 from a back surface 11b side through the venting holes communicating with the respective suction holes 21.

A plurality (in this embodiment, four pieces) of recording heads 24 of an elongated line head system, as fluid ejecting heads, is provided above the platen 20 so as to face the upper surface of the platen 20 in the up-and-down direction. Also, the respective recording heads 24 are disposed to extend in parallel to the width direction (a direction perpendicular to the transport direction of the recording paper 11, and in FIG. 1, a direction perpendicular to the plane of the paper) of the transport belt 16 and also to be parallel to the transport direction of the recording paper 11. Each recording head 24 is connected to an ink cartridge 26 through an ink supply tube 25. Then, to the respective recording heads 24, different types (colors) of ink are supplied from the respectively corresponding ink cartridge 26.

A number of nozzles (not shown) for ejecting ink supplied from the ink cartridge 26 are provided at the bottom of each recording head 24. Then, by sequentially ejecting ink from the respective nozzles to the recording paper 11 at a timing according to the transport speed of the recording paper 11 which is transported by the transport belt 16, an image is formed on a surface 11a which becomes a printing surface of the recording paper 11.

Also, at the downstream side (in FIG. 1, the right side) of the belt transport device 12, a paper discharging device 28 for discharging the recording paper 11, in which a printing process (recording process) has been carried out on the transport belt 16, to a paper discharge tray 27 is provided.

The paper discharging device 28 includes a flow path forming member 30 made into a hollow shape. Then, a passage flow path 31 having a rectangular cross section, through which the recording paper 11 can pass in a non-contact state, is formed in the flow path forming member 30. The flow path forming member 30 includes a linear flow path section 32 which linearly extends along the transport direction (in FIG. 1, the left-and-right direction) of the recording paper 11 by the belt transport device 12, and first and second flow path sections 33 and 34 which extend by being bifurcated in the up-and-down direction with the downstream-side end portion of the linear flow path section 32 as a bifurcation portion.

Then, in the linear flow path section 32, an opening which is located at one end side (the upstream side in the transport direction) in a longitudinal direction becomes a carrying-in port 35 which carries in the recording paper 11 which is carried out from the belt transport device 12, into the passage flow path 31. Also, the first flow path section 33 is configured so as to extend by being curved in a semicircular arc shape to warp upward from the downstream-side end portion of the linear flow path section 32. Then, in the first flow path section 33, an opening which is located at the other end side (the downstream side in the transport direction) in a longitudinal direction becomes a discharge port 36 which discharges the recording paper 11 carried into the passage flow path 31 to the paper discharge tray 27. On the other hand, the second flow path section 34 is configured so as to extend by being curved in a semicircular arc shape to warp downward from the downstream-side end portion of the linear flow path section 32. Then, in the second flow path section 34, an opening which is located at the other end side (the downstream side in the transport direction) in a longitudinal direction becomes a carrying-out port 37 which carries out the recording paper 11 carries into the passage flow path 31 onto the platen 20 through the gate rollers 18.

Also, at an upper wall of the linear flow path section 32, a first blowing path 38 which communicates with the inside of the linear flow path section 32 from above is provided at a position in the vicinity of the carrying-in port 35. Also, the first blowing path 38 is provided to linearly extend in a direction intersecting the transport direction of the recording paper 11 and in a direction inclined toward the upstream side in the transport direction of the recording paper 11.

Also, a first fan 40 is connected to the first blowing path 38 so as to block an opening portion 39 opened obliquely upward. The first fan 40 blows air approximately evenly into the first blowing path 38 by rotation of a rotating vane housed on the inside thereof. Then, the first fan 40 introduces air (gas) taken in from the outside into the first blowing path 38 through the opening portion 39, into the passage flow path 31 of the linear flow path section 32 through the first blowing path 38.

Also, at a lower wall of the linear flow path section 32, a second blowing path 41 which communicates with the inside of the linear flow path section 32 from below is provided approximately at the same position in the transport direction of the recording paper 11 as that of the first blowing path 38. Also, the second blowing path 41 is provided to linearly extend in a direction intersecting the transport direction of the recording paper 11 and in a direction inclined toward the upstream side in the transport direction of the recording paper 11.

Also, a second fan 43 is connected to the second blowing path 41 so as to block an opening portion 42 opened obliquely downward. The second fan 43 blows air approximately evenly into the second blowing path 41 by rotation of a rotating vane housed on the inside thereof. Then, the second fan 43 introduces air (gas) taken in from the outside into the second blowing path 41 through the opening portion 42, into the passage flow path 31 of the linear flow path section 32 through the second blowing path 41.

Also, an opening portion 30a is formed between a wall portion 33a which is located at the outside in a curvature direction of the first flow path section 33 in the flow path forming member 30, and a wall portion 34a which is located at the outside in a curvature direction of the second flow path section 34. Then, a flow path allocation member 44 as a communication switching section is disposed so as to partially block the opening portion 30a at a position where the flow path allocation member becomes the bifurcation portion of the first flow path section 33 and the second flow path section 34.

As shown in FIG. 1, the flow path allocation member 44 is an approximately prismatic body having an approximate triangle shape in cross section perpendicular to an axial direction (a direction perpendicular to the plane of paper of FIG. 1) thereof and has two concave curved surfaces 44a and 44b curved inward, as faces defining the side faces in the approximately prismatic body. Then, among these concave curved surfaces 44a and 44b, the concave curved surface 44a on one side has the same curvature as the curvature of the inner surface of the wall portion 33a which is located at the outside in the curvature direction of the first flow path section 33 in the first flow path section 33. On the other hand, the concave curved surface 44b on the other side has the same curvature as the curvature of the inner surface of the wall portion 34a which is located on the outside in the curvature direction of the second flow path section 34 in the second flow path section 34.

Also, in an end portion on the side adjacent to the wall portion 33a of the first flow path section 33 in the concave curved-surface 44a, and an end portion on the side adjacent to the wall portion 34a of the second flow path section 34, cutout portions 45a and 45b respectively corresponding to the thicknesses of the corresponding wall portions 33a and 34a are respectively formed. Then, if the flow path allocation member 44 turns around a turning shaft 46 which extends in the width direction (a direction perpendicular to the plane of paper in FIG. 1) of the recording paper 11, the cutout portions 45a and 45b formed in the concave curved-surfaces 44a and 44b are respectively engaged with the corresponding wall portions 33a and 34a. In addition, the turning shaft 46 of the flow path allocation member 44 is located on an axis line which passes the center position of the cross-sectional shape of the passage flow path 31 in the linear flow path section 32.

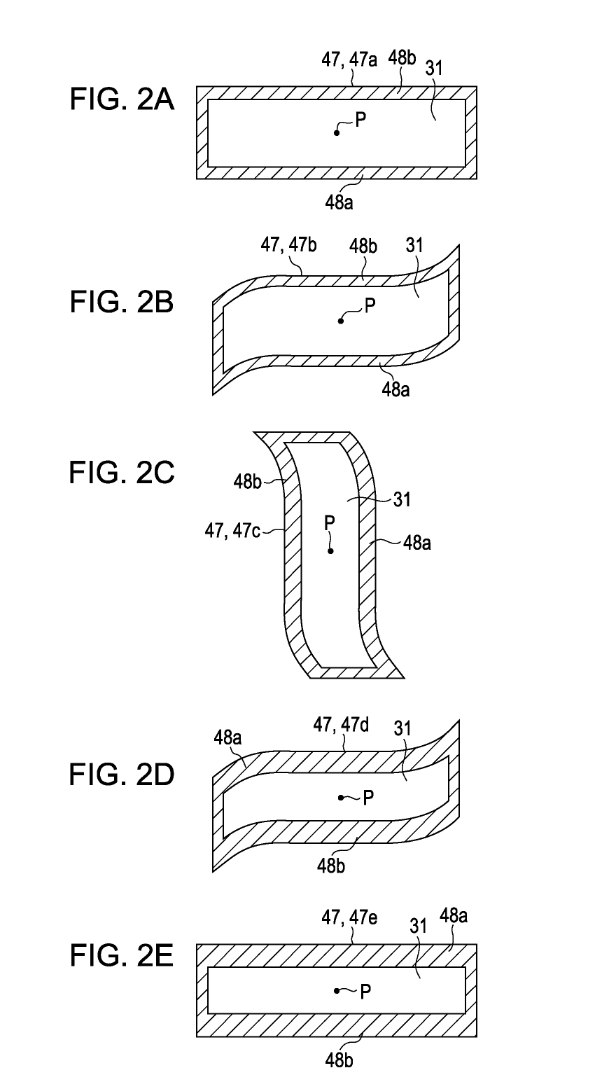

Also, as shown in FIG. 1, at the second flow path section 34, a reversing flow path portion 47 is provided, which reverses the recording paper 11 by passing the recording paper 11 while twisting and rotating the recording paper 11. The reversing flow path portion 47 is made such that the cross-sectional shape of the passage flow path 31 of the inside thereof has a point-symmetric structure centered on an axis line P which passes the center position of the cross-sectional shape of the passage flow path 31. Then, as shown in FIGS. 2A to 2E, the reversing flow path portion 47 is formed such that the cross-sectional shape of the passage flow path 31 thereof is sequentially twisted around the axis line P in a process from an upstream-side end portion 47a, which becomes an entrance of the reversing flow path portion 47, through an upstream-side portion 47b, an intermediate portion 47c, and a downstream-side portion 47d, to a downstream-side end portion 47e, thereby eventually being twisted by 180 degrees.

Specifically, as shown in FIG. 2A, the cross-sectional shape of the passage flow path 31 in the upstream-side end portion 47a of the reversing flow path portion 47 is of a rectangular shape forming a straight wall form which a first wall portion 48a that the surface 11a of the recording paper 11 which is transported in the passage flow path 31 faces and a second wall portion 48b that the back surface 11b of the recording paper 11 faces likewise are parallel to each other. Then, the upstream-side portion 47b is continuously formed at the downstream side of the upstream-side end portion 47a so as to be gradually twisted and rotated.

Also, as shown in FIG. 2B, the cross-sectional shape of the passage flow path 31 in the upstream-side portion 47b of the reversing flow path portion 47 is of a shape (hereinafter referred to as a “twisted cross-sectional shape”) distorted and deformed such that the respective sites that are located on one side (in FIG. 2B, the right side) and the other side (in FIG. 2B, the left side) in the width direction of the recording paper 11 are bent in opposite directions, as it goes toward the downstream side in the transport direction. That is, the first wall portion 48a and the second wall portion 48b of the passage flow path 31 in the upstream-side portion 47b are distorted and deformed such that when viewing from the upstream side in the transport direction of the recording paper 11, the site further on one side (in FIG. 2B, the right side) than the axis line P is bent upward and also the site further on the other side (in FIG. 2B, the left side) than the axis line P is bent downward. Then, the upstream-side portion 47b connects the upstream-side end portion 47a and the intermediate portion 47c while the cross-sectional shape of the passage flow path 31 in the upstream-side portion 47b is twisted around the axis line P in the counterclockwise direction as viewed from the upstream side in the transport direction.

Also, as shown in FIG. 2C, the cross-sectional shape of the passage flow path 31 in the intermediate portion 47c of the reversing flow path portion 47 is formed so as to form a structure more twisted than the upstream-side portion 47b in the counterclockwise direction as viewed from the upstream side in the transport direction while maintaining the same twisted cross-sectional shape as the cross-sectional shape of the passage flow path 31 in the upstream-side portion 47b. Then, at an intermediate position in the longitudinal direction of the reversing flow path portion 47, that is, a middle point between the upstream-side end portion 47a and the downstream-side end portion 47e, the cross-sectional shape is formed so as to form a cross-sectional shape rotated by 90 degrees around the axis line P further than the case of the upstream-side end portion 47a in the counterclockwise direction as viewed from the upstream side in the transport direction. Then, the intermediate portion 47c connects the upstream-side portion 47b and the downstream-side portion 47d while the cross-sectional shape of the passage flow path 31 in the intermediate portion 47c is twisted around the axis line P in the counterclockwise direction as viewed from the upstream side in the transport direction.

Also, as shown in FIG. 2D, the cross-sectional shape of the passage flow path 31 in the downstream-side portion 47d of the reversing flow path portion 47 is formed so as to form a structure more twisted than the intermediate portion 47c in the counterclockwise direction as viewed from the upstream side in the transport direction while maintaining the same twisted cross-sectional shape as the cross-sectional shape of the passage flow path 31 in the intermediate portion 47c. Then, the downstream-side portion 47d connects the intermediate portion 47c and the downstream-side end portion 47e while the cross-sectional shape of the passage flow path 31 in the downstream-side portion 47d is twisted around the axis line P in the counterclockwise direction as viewed from the upstream side in the transport direction.

Also, as shown in FIG. 2E, the cross-sectional shape of the passage flow path 31 in the downstream-side end portion 47e of the reversing flow path portion 47 is of a rectangular shape forming a straight wall form in which the first wall portion 48a and the second wall portion 48b are parallel to each other, similarly to the case of the upstream-side end portion 47a. However, in the downstream-side end portion 47e, the cross-sectional shape of the passage flow path 31 thereof is formed so as to form a cross-sectional shape rotated by 180 degrees around the axis line P further than the case of the upstream-side end portion 47a shown in FIG. 2A, in the counterclockwise direction as viewed from the upstream side in the transport direction. That is, in the reversing flow path portion 47, the cross-sectional shape of the passage flow path 31 thereof is formed so as to make the surface 11a and the back surface 11b of the recording paper 11 be at opposite positions in the up-and-down direction (that is, to reverse the recording paper) by twisting and rotating the recording paper 11 introduced from the upstream-side end portion 47a into the passage flow path 31, on the way in which the recording paper 11 passes through the upstream-side portion 47b, the intermediate portion 47c, and the downstream-side portion 47d and reaches the downstream-side end portion 47e.

In addition, as shown in FIGS. 2A to 2E, among the wall portions surrounding and forming the passage flow path 31 in the reversing flow path portion 47, the first wall portion 48a and the second wall portion 48b, which respectively face the surface 11a and the back surface 11b of the recording paper 11, are configured such that the respective thicknesses (wall thicknesses) gradually become large as it goes toward the downstream side in the reversing flow path portion 47, while a distance between outer surfaces thereof is maintained constant. For this reason, the flow path cross-section area of the passage flow path 31 in the reversing flow path portion 47 is configured so as to gradually become small as it goes toward the downstream side.

Next, with respect to an action of the ink jet printer 10 configured as described above, an explanation will be made below focusing on, in particular, an action when the paper discharging device 28 transports the recording paper 11 carries into the passage flow path 31 toward the downstream side in the transport direction. In addition, in the initial state, since the flow path allocation member 44 makes the cutout portion 45b be engaged with the wall portion 34a of the second flow path section 34, the paper discharging device 28 is set to be in a state (a second state) where the passage flow path 31 of the linear flow path section 32 and the passage flow path 31 of the second flow path section 34 communicate with each other.

Now, in a previous step in which the recording paper 11 is transported from the belt transport device 12, the paper discharging device 28 drives the first fan 40 and the second fan 43. Then, the first fan 40 and the second fan 43 introduce air taken in from the outside, into the passage flow path 31 of the linear flow path section 32 through the respective blowing paths 38 and 41. Here, air which is blown in from the first fan 40 and the second fan 43 through the respective blowing paths 38 and 41 flows in an inclined direction toward the downstream side in the transport direction of the recording paper 11. That is, air which is blown in from the first fan 40 and the second fan 43 has a velocity component heading to the downstream side in the transport direction of the recording paper 11. For this reason, in the passage flow path 31 of the linear flow path section 32, air flows heading to the downstream side in the transport direction of the recording paper 11 along the inner surfaces of the linear flow path section 32 are created by air which is blown in from the first fan 40 and the second fan 43.

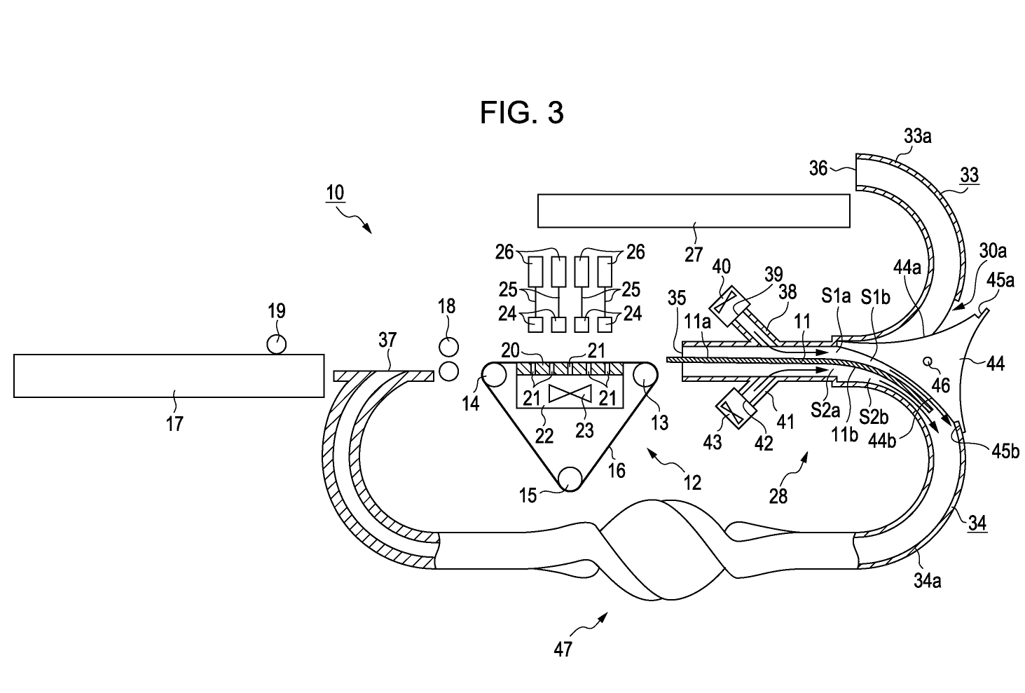

Then, as shown in FIG. 3, if the belt transport device 12 revolves the transport belt 16 by rotationally driving the driving roller 13, the rear end of the recording paper 11 placed on the transport belt 16 is separated from the transport belt 16 and also the front end thereof is transported into the passage flow path 31 of the linear flow path section 32 through the carrying-in port 35. Here, air which is blown in from the first fan 40 and the second fan 43 flows in a direction separating from the inner surfaces of the linear flow path 32. For this reason, the recording paper 11 is biased in a direction separating from the inner surfaces of the passage flow path 31 of the linear flow path section 32 by air which is introduced from the respective fans 40 and 43 into the passage flow path 31 of the linear flow path section 32. Also, both ends in the width direction of the recording paper 11 are close to the inner surfaces of the passage flow path 31 of the linear flow path section 32 with a slight gap interposed therebetween. For this reason, the passage flow path 31 of the linear flow path section 32 is in a state where it is approximately divided into a spatial region S1a on the surface 11a side of the recording paper 11 and a spatial region S2a on the back surface 11b side of the recording paper 11, by the recording paper 11.

Then, into the spatial region S1a on the surface 11a side of the recording paper 11, air is blown in from the first fan 40, whereby an air flow heading to the downstream side in the transport direction of the recording paper 11 is generated. On the other hand, into the spatial region S2a on the back surface 11b side of the recording paper 11, air is blown in from the second fan 43, whereby an air flow heading to the downstream side in the transport direction of the recording paper 11 is generated. In this case, on the surface 11a of the recording paper 11, a frictional force acts in a flow direction of air between it and air which is blown in from the first fan 40. Also, on the back surface 11b of the recording paper 11, a frictional force acts in a flow direction of air between it and air which is blown in from the second fan 43. For this reason, the paper discharging device 28 makes a propulsion force heading to the downstream side in the transport direction of the recording paper 11 act on the recording paper 11 even in a state where the rear end of the recording paper 11 is separated from the transport belt 16, so that a transport force which is transmitted from the belt transport device 12 to the recording paper 11 is eliminated.

Here, if the concave curved surface 44b of the flow path allocation member 44 is disposed so as to be continuous with the inner surface of the second flow path section 34, the concave curved surface 44b of the flow path allocation member 44 and the inner surface of the second flow path section 34 form a curved surface having constant curvature. For this reason, air which is blown in from the first fan 40 flows along the concave curved-surface 44b of the flow path allocation member 44 and then flows into a spatial region S1b on the surface 11a side of the recording paper 11 in the passage flow path 31 of the second flow path section 34. On the other hand, air which is blown in from the second fan 43 passes through the spatial region S2a on the back surface 11b side of the recording paper 11 in the passage flow path 31 of the linear flow path section 32 and then flows into a spatial region S2b on the back surface 11b side of the recording paper 11 in the passage flow path 31 of the second flow path section 34.

Then, on the recording paper 11 which is located at the passage flow path 31 of the second flow path section 34, the propulsion forces act equally on both the surface 11a and the back surface 11b by air which is blown in from the first fan 40 and the second fan 43. Then, the recording paper 11 is transported toward the downstream side in the transport direction in the passage flow path 31 of the second flow path section 34 while maintaining a state where both the surface 11a and the back surface 11b are separated from the inner surfaces of the second flow path section 34. As a result, the leading end of the recording paper 11 reaches the upstream-side end portion 47a of the reversing flow path portion 47 in the second flow path section 34 and then enters from the upstream-side end portion 47a into the upstream-side portion 47b in the passage flow path 31 of the reversing flow path portion 47.

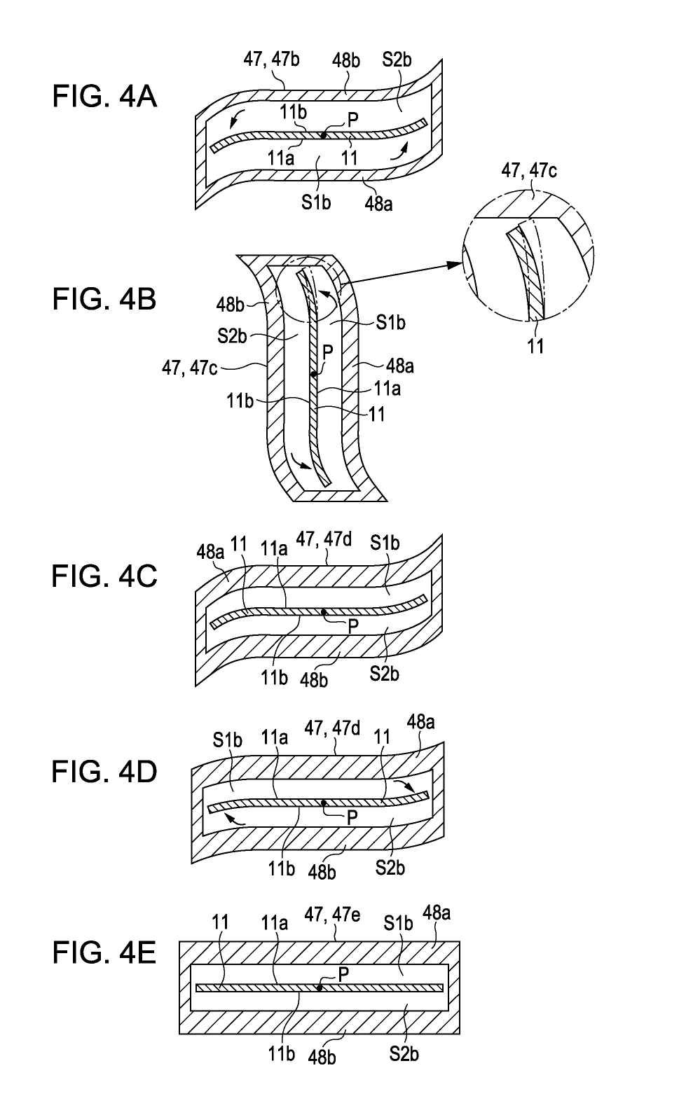

Here, as shown in FIG. 4A, in the upstream-side portion 47b of the reversing flow path portion 47, air which is blown in from the first fan 40 flows in the spatial region S1b on the surface 11a side of the recording paper 11. Then, air which flows in the spatial region that is located at one side (in FIG. 4A, the right side) in the width direction of the recording paper 11, in the spatial region S1b on the surface 11a side of the recording paper 11, flows along the inner surface of the passage flow path 31 distorted and deformed so as to be bent upward. Then, air flowing in the spatial region obtains a velocity component to a direction turning around the axis line P in the counterclockwise direction as viewed from the upstream side in the transport direction. As a result, in a process in which the recording paper 11 passes through the upstream-side portion 47b of the reversing flow path portion 47, one side in the width direction of the recording paper 11 is biased in a direction in which it is separated from the inner surface of the reversing flow path portion 47, by the air flow. Then, one side in the width direction of the recording paper 11 is bent and deformed around the axis line P in the counterclockwise direction as viewed from the upstream side in the transport direction.

Also, similarly, in the upstream-side portion 47b of the reversing flow path portion 47, air which is blown in from the second fan 43 flows in the spatial region S2b on the back surface 11b side of the recording paper 11. Then, air which flows in the spatial region that is located on the other side (in FIG. 4A, the left side) in the width direction of the recording paper 11, in the spatial region S2b on the back surface 11b side of the recording paper 11, flows along the inner surface of the passage flow path 31 distorted and deformed so as to be bent downward. Then, air flowing in the spatial region obtains a velocity component in a direction turning around the axis line P in the counterclockwise direction as viewed from the upstream side in the transport direction. As a result, in a process in which the recording paper 11 passes through the upstream-side portion 47b of the reversing flow path portion 47, the other side in the width direction of the recording paper 11 is biased in a direction in which it is separated from the inner surface of the reversing flow path portion 47, by the air flow. Then, the other side in the width direction of the recording paper 11 is bent and deformed around the axis line P in the counterclockwise direction as viewed from the upstream side in the transport direction.

Also, as shown in FIG. 4B, it is assumed that the leading end of the recording paper 11 reaches the intermediate portion 47c of the reversing flow path portion 47 in the second flow path section 34. In this case, in the intermediate portion 47c of the reversing flow path portion 47, air which is blown in from the first fan 40 flows in the spatial region S1b on the surface 11a side of the recording paper 11 and on the other hand, air which is blown in from the second fan 43 flows in the spatial region S2b on the back surface 11b side of the recording paper 11. Then, this air respectively flows along the inner surfaces of the passage flow path 31 extending while being twisted around the axis line P in the counterclockwise direction as viewed from the upstream side in the transport direction. Then, air in these spatial regions S1b and S2b is further biased to a direction turning around the axis line P in the counterclockwise direction as viewed from the upstream side in the transport direction. Then, in a process in which the recording paper 11 passes through the intermediate portion 47c of the reversing flow path portion 47, the recording paper 11 is biased to the counterclockwise direction around the axis line P as viewed from the upstream side in the transport direction by the air flow. As a result, as shown in FIG. 4C, the recording paper 11 is reversed by rotating by 180 degrees around the axis line P without coming into contact with the inner surfaces of the passage flow path 31 of the reversing flow path portion 47.

Incidentally, if disturbance occurs in the flow of air flowing in the passage flow path 31 of the reversing flow path portion 47, both ends in the width direction of the recording paper 11 may be bent and deformed in a direction opposite to the twisted direction of the reversing flow path portion 47. In this regard, according to this embodiment, as shown in FIG. 4B, the intermediate portion 47c of the reversing flow path portion 47 is designed such that the dimension of the passage flow path 31 in the same direction as the width direction of the recording paper 11 is slightly smaller than the dimension in the width direction of the recording paper 11. Then, since the end portions in the width direction of the recording paper 11 are engaged with the inner surfaces of the reversing flow path portion 47, the additional bending deformation of the end portions in the width direction of the recording paper 11 in a direction opposite to the twisted direction of the reversing flow path portion 47 is regulated by the inner surfaces of the reversing flow path portion 47.

Also, the intermediate portion 47c of the reversing flow path portion 47 is configured such that the flow path cross-section area of the passage flow path 31 gradually becomes small as it goes toward the downstream side. For this reason, the flow velocity of air which is blown in from the first fan 40 and the second fan 43 gradually increases as air flows from the upstream side toward the downstream side in the passage flow path 31 of the reversing flow path portion 47. Therefore, the recording paper 11 is reversed while always receiving a force pulling it toward the downstream side in the transport direction.

Further, as shown in FIG. 4D, it is assumed that the leading end of the recording paper 11 reaches the downstream-side portion 47d of the reversing flow path portion 47 in the second flow path section 34. In this case, in the downstream-side portion 47d of the reversing flow path portion 47, air which is blown from the first fan 40 flows in the spatial region S1b on the surface 11a side of the recording paper 11. Then, air which flows in the spatial region that is located on one side (in FIG. 4D, the right side) in the width direction of the recording paper 11, in the spatial region S1b on the surface 11a side of the recording paper 11, flows along the inner surface of the passage flow path 31 distorted and deformed so as to reduce the upward warpage. Then, air flowing in this spatial region obtains a velocity component to a direction turning around the axis line P in the clockwise direction as viewed from the upstream side in the transport direction. As a result, in a process in which the recording paper 11 passes through the downstream-side portion 47d of the reversing flow path portion 47, one side in the width direction of the recording paper 11 is biased to a direction in which it is separated from the inner surface of the reversing flow path portion 47, by the air flow.

Also, similarly, in the downstream-side portion 47d of the reversing flow path portion 47, air which is blown from the second fan 43 flows in the spatial region S2b on the back surface 11b side of the recording paper 11. Then, air which flows in the spatial region that is located at the other side (in FIG. 4D, the left side) in the width direction of the recording paper 11, in the spatial region S2b on the back surface 11b side of the recording paper 11, flows along the inner surface of the passage flow path 31 distorted and deformed so as to reduce the downward warpage. Then, air flowing in this spatial region obtains a velocity component in a direction turning around the axis line P in the clockwise direction as viewed from the upstream side in the transport direction. As a result, in a process in which the recording paper 11 passes through the downstream-side portion 47d of the reversing flow path portion 47, the other side in the width direction of the recording paper 11 is biased to a direction in which it is separated from the inner surface of the reversing flow path portion 47, by the air flow. Then, as shown in FIG. 4E, in a process in which the recording paper 11 passes through the downstream-side end portion 47e of the reversing flow path portion 47, the transport position of the recording paper 11 is corrected so as to be approximately horizontal.

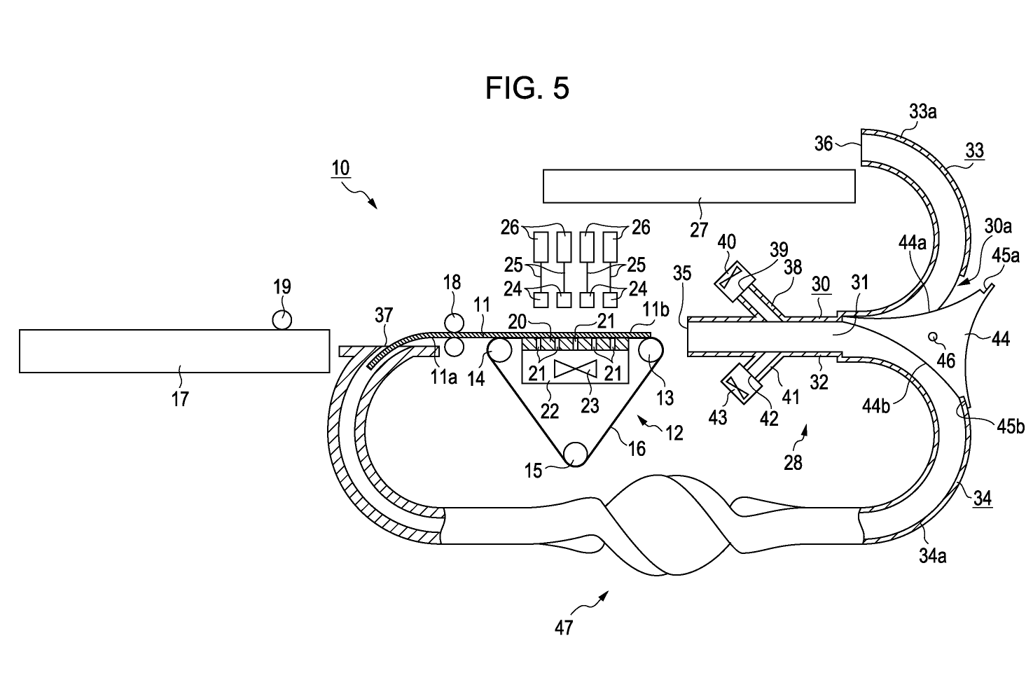

Also, the recording paper 11 passed through the reversing flow path portion 47 of the second flow path section 34 is transported toward the downstream side in the transport direction in the passage flow path 31 of the second flow path section 34 while maintaining an aspect extending approximately parallel to the inner surface of the second flow path section 34. Then, as shown in FIG. 5, the recording paper 11 carried out from the carrying-out port 37 of the second flow path section 34 is fed to the belt transport device 12 through the gate rollers 18 in a state where the back surface 11b of the recording paper 11 faces upward. Thereafter, an image is also formed on the back surface 11b of the recording paper 11 by sequentially ejecting ink from each nozzle onto the recording paper 11 at a timing according to the transport speed of the recording paper 11 which is transported by the transport belt 16.

Also, the paper discharging device 28 makes the cutout portion 45a of the flow path allocation member 44 be engaged with the wall portion 33a of the first flow path section 33 by turning the flow path allocation member 44 around the turning shaft 46 at a point in time when a printing process on the recording paper 11 by the recording heads 24 has been completed. Then, the paper discharging device 28 is switched to a state (a first state) where the passage flow path 31 of the linear flow path section 32 communicates with the passage flow path 31 of the first flow path section 33.

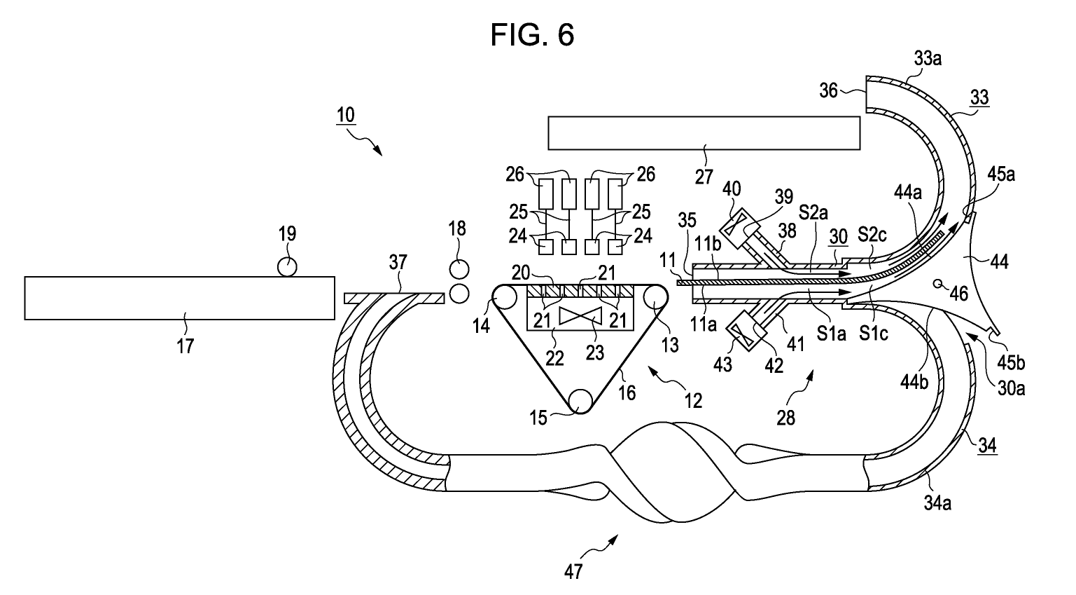

Also, at the same time, as shown in FIG. 6, if the belt transport device 12 revolves the transport belt 16 by rotationally driving the driving roller 13, the rear end of the recording paper 11 placed on the transport belt 16 is separated from the transport belt 16 and also the front end thereof is transported into the passage flow path 31 of the linear flow path section 32 through the carrying-in port 35. Then, the recording paper 11 is transported to the inner deep side of the passage flow path 31 of the linear flow path section 32 by an action of a propulsion force from air flowing in the passage flow path 31 of the linear flow path section 32.

Here, if the concave curved-surface 44a of the flow path allocation member 44 is disposed so as to be continuous with the inner surface of the first flow path section 33, the concave curved-surface 44a of the flow path allocation member 44 and the inner surface of the first flow path section 33 form a curved surface having constant curvature. For this reason, air which is blown in from the first fan 40 passes through the spatial region S2a on the back surface 11b side of the recording paper 11 in the passage flow path 31 of the linear flow path section 32 and then flows into a spatial region S2c on the back surface 11b side of the recording paper 11 in the passage flow path 31 of the first flow path section 33. On the other hand, air which is blown in from the second fan 43 flows along the concave curved-surface 44a of the flow path allocation member 44 and then flows into a spatial region S1c on the surface 11a side of the recording paper 11 in the passage flow path 31 of the first flow path section 33. Then, the recording paper 11 is transported to the discharge port 36 of the flow path forming member 30 while maintaining an aspect extending approximately in parallel to the inner surface of the first flow path section 33, with the air flow of air which is blown in from these fans 40 and 43 as a propulsion force.

According to this embodiment, the following effects can be obtained.

(1) The recording paper 11 is reversed without coming into contact with the inner surfaces of the passage flow path 31, by air flowing in the passage flow path 31. For this reason, even in the case of reversing the recording paper 11 at a position on the way of the passage flow path 31, it is possible to avoid occurrence of a transport jam of the recording paper 11 in the passage flow path 31.

(2) Both sides in the width direction of the recording paper 11 are reversed in the same direction with the axis line P extending in the transport direction of the recording paper 11 as a rotation center, in a process in which the recording paper 11 passes through the reversing flow path portion 47. For this reason, since a biasing force from air acts on the recording paper 11 in a balanced manner, it is possible to smoothly reverse the recording paper 11.

(3) The flow velocity of air flowing in the reversing flow path portion 47 gradually increases as the flow path cross-section area of the reversing flow path portion 47 gradually becomes small. For this reason, the recording paper 11 is reversed while always receiving a force pulling it toward the downstream side in the transport direction, so that it is possible to avoid an occurrence of a transport jam of the recording paper 11 in the reversing flow path portion 47.

(4) Since the recording paper 11 is reversed without coming into contact with the inner surfaces of the passage flow path 31, the recording paper 11 does not make the surface 11a with ink ejected from the recording heads 24 come into contact with the inner surface of the passage flow path 31. For this reason, after the recording paper 11, in which a printing process with respect to the surface 11a has been completed, is reversed while suppressing disturbance of a printed image formed on the surface 11a of the recording paper 11, a printing process can also be carried out with respect to the back surface 11b of the recording paper 11 by the recording heads 24. That is, it is possible to carry out double-side printing with respect to the recording paper 11 while suppressing disturbance of a printed image formed on the recording paper 11.

(5) In a case where the flow path allocation member 44 is in the first state where it makes the carrying-in port 35 communicate with the first flow path section 33 in the bifurcation portion of the passage flow path 31, after the recording paper 11 passes through the first flow path section 33, the recording paper 11 is discharged from the inside of the passage flow path 31 to the paper discharge tray 27, which is located further at the downstream side than the recording heads 24 in a transport pathway, through the discharge port 36. On the other hand, in a case where the flow path allocation member 44 is in the second state where it makes the carrying-in port 35 communicate with the second flow path section 34 in the bifurcation portion of the passage flow path 31, after the recording paper 11 is reversed in a process in which it passes through the reversing flow path portion 47 of the second flow path section 34, the recording paper 11 is carried out from the inside of the passage flow path 31 to a position which is further on the upstream side than the recording heads 24 in the transport pathway, through the carrying-out port 37. For this reason, the recording heads 24 can eject ink in order to form an image also with respect to the back surface 11b of the recording paper 11. That is, by switching the flow path allocation member 44 to any of the first state and the second state, it is possible to carry out an image forming process to both sides of the recording paper 11 as necessary or discharge the recording paper 11, in which image formation has been completed, from the inside of the passage flow path 31 to the paper discharge tray 27, which is located further on the downstream side than the recording heads 24 in the transport pathway.

(6) The intermediate portion 47c of the reversing flow path portion 47 is designed such that the width dimension of the passage flow path 31 is smaller than the width dimension of the recording paper 11. For this reason, in a case where the recording paper 11 is biased in the opposite direction to the reversing direction of the recording paper 11 due to disturbance of the air flow in the passage flow path 31 in a process in which the recording paper 11 passes through the passage flow path 31 of the reversing flow path portion 47, one end in the width direction of the recording paper 11 is engaged with the inner surface of the passage flow path 31 of the reversing flow path portion 47. Then, additional bending deformation of one end in the width direction of the recording paper 11 in the same direction is regulated. Therefore, since large bending deformation of the recording paper 11 in the reversing flow path portion 47 is regulated, it is possible to reliably avoid an occurrence of a transport jam of the recording paper 11 in the reversing flow path portion 47.

In addition, the above-described embodiment may be modified into another embodiment as described below.

In the above-described embodiment, the paper discharging device 28 may be configured such that the carrying-out port 37 of the second flow path section 34 is disposed at a position which is further on the downstream side in the transport direction than the flow path forming member 30. According to this configuration, by separately disposing a paper discharge tray in the vicinity of the carrying-out port 37, it is possible to distinguish a paper discharge tray for stacking the reversed recording papers 11 and a paper discharge tray for stacking the non-reversed recording papers 11.

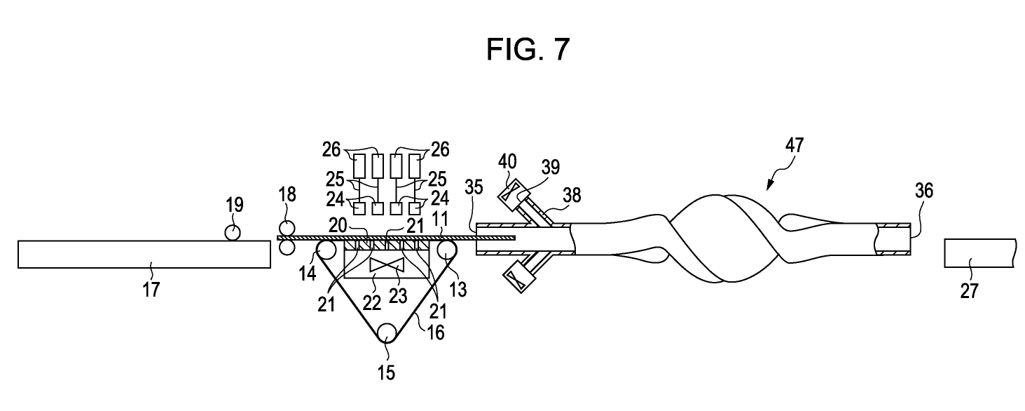

In the above-described embodiment, as shown in FIG. 7, the paper discharging device 28 may be configured such that the passage flow path 31 of the flow path forming member 30 is not bifurcated and also the reversing flow path portion 47 for reversing the recording paper 11 is provided at a position on the way of the passage flow path 31.

According to this configuration, since the recording paper 11 is reversed in a process in which it passes through the reversing flow path portion 47 in a horizontal direction, it is possible to stack the recording paper 11 on the paper discharge tray 27 in a state where the surface 11a of the recording paper 11 faces downward.

In the above-described embodiment, the reversing flow path portion 47 may be configured such that the flow path cross-section area of the passage flow path 31 is approximately constant over the entire area in the transport direction of the recording paper 11 or may be configured such that the flow path cross-section area of the passage flow path 31 gradually becomes large as it goes toward the carrying-out port 37. In this case, in the reversing flow path portion 47, in order to sufficiently secure the flow velocity of air in the vicinity of the downstream end of the reversing flow path portion 47, it is preferable to provide mechanisms for introducing air into the passage flow path 31 at a plurality of positions along the transport direction of the recording paper 11 in the second flow path section 34.

In the above-described embodiment, the reversing flow path portion 47 may be constituted by a plurality of reversing flow path elements, in each of which a twist angle around the axis line P is arbitrarily set. In this case, these reversing flow path elements may be disposed adjacent to each other at a position on the way of the second flow path section 34 or may be disposed apart from each other at a position on the way of the second flow path section 34.

In the above-described embodiment, the passage flow path 31 of the reversing flow path portion 47 may be formed into a structure twisted around an axis line Passing a position different from the center position of the flow path cross-sectional shape of the passage flow path 31.

In the above-described embodiment, the intermediate portion 47c of the reversing flow path portion 47 may be designed such that the width dimension of the passage flow path 31 is slightly larger than the width dimension of the recording paper 11.

In the above-described embodiment, the flow path forming member 30 may be configured so as to be able to move the side surfaces of the passage flow path 31 in the width direction of the recording paper 11.

According to this configuration, the paper discharging device 28 can transport a plurality of types of recording paper 11 having different dimensions in the width direction with each other.

In the above-described embodiments, as the target, another material such as a resin film may be adopted. However, it is preferable to adopt a low-stiffness material as the target so as to allow the material to pass through the passage flow path 31 of the reversing flow path portion 47.

In the above-described embodiments, as the ink jet printer 10, a serial system or a lateral system may be adopted in which at the time of printing, the recording heads 24 eject ink while reciprocating along the transport plane of the recording paper 11.

In the above-described embodiments, as the fluid ejecting apparatus, a fluid ejecting apparatus that ejects or discharges fluid other than ink may be adopted. The invention can be applied to various fluid consuming apparatuses which are each provided with a fluid ejecting head or the like that discharge a minutely small amount of fluid droplet. In addition, the fluid droplet describes the state of fluid which is discharged from the above-described fluid ejection apparatus, and also includes droplets of a granular shape or a tear shape, or droplets tailing into a line. Also, it is acceptable if the fluid as mentioned herein is a material that a fluid consuming apparatus can eject. For example, it is acceptable if the fluid is a substance in a state when the substance is in a liquid phase, and the fluid includes not only liquids in a liquid state with high or low viscosity, a flow state such as sol, gel water, other inorganic or organic solvents, solution, liquid resin, or liquid metal (metal melt), and one state of substance, but also a material in which particles of a functional material composed of a solid material such as pigment or metal particles are dissolved, dispersed, or mixed in a solvent, or the like. Also, ink as described in the above-described embodiments or the like can be given as representative examples of the fluid. Here, ink is set to include general water-based ink and oil-based ink and various fluid compositions such as gel ink and hot-melt ink. As specific examples of the fluid consuming apparatus, the following can be given: a fluid ejecting apparatus that ejects liquids that include, in a dispersed or dissolved form, materials such as an electrode material or a color material, which is used for the manufacturing or the like of, for example, a liquid crystal display, an EL (electroluminescence) display, a surface-emitting display, or a color filter; a fluid ejecting apparatus that ejects a biological organic matter that is used for the manufacturing of biochips; a fluid ejecting apparatus that is used as a precision pipette and ejects fluid that is a sample; a textile printing apparatus; a micro-dispenser; and the like. Further, the following fluid ejecting apparatuses may be adopted: a fluid ejecting apparatus that ejects lubricant oil to a precision machine such as a clock or a camera by using a pinpoint; a fluid ejecting apparatus that ejects a transparent resin solution such as ultraviolet curing resin onto a substrate in order to form a minute hemispherical lens (an optical lens) or the like which is used in an optical communication element or the like; and a fluid ejecting apparatus that ejects an etching solution such as acid or alkali in order to etch a substrate or the like.

What is claimed is:

1. A fluid ejecting apparatus that ejects liquid from a fluid ejecting head which ejects fluid, onto a target which is transported in a transport pathway, the apparatus comprising:
a passage flow path which passes the target with the liquid ejected thereto and gas on the downstream side of the fluid ejecting head in the transport pathway;
a reversing flow path portion which is connected to the passage flow path and reverses the front side and the back side of the target by rotating the target with an axis line extending in a transport direction as a rotation center; and
a carrying-out port which carries out the target passed through the reversing flow path portion, to a position which is further on the upstream side than the ejecting head.

2. The fluid ejecting apparatus according to claim 1, wherein the reversing flow path portion has a flow path cross-sectional shape that is a point-symmetric shape with the axis line as the center.

3. The fluid ejecting apparatus according to claim 1, wherein the reversing flow path portion is configured such that a flow path cross-section area gradually becomes small as it goes from the upstream side to the downstream side in the transport direction.

4. The fluid ejecting apparatus according to claim 1, wherein the passage flow path further includes:
a first flow path section,
a second flow path section which is connected to the reversing flow path portion,
a bifurcation portion which bifurcates into the first flow path section and the second flow path section, and
a switching section which is disposed at the bifurcation portion and switches between the state of transporting the target to the first flow path section and the state of transporting the target to the second flow path section.
